(19) United States
(12) Patent Application Publication
(10) Pub. No.: US 2012/0284150 A1
(43) Pub. Date: Nov. 8, 2012

(54) INVENTORY MANAGEMENT SYSTEM AND METHOD

(76) Inventor: Bradford Stanley, Calabasas, CA (US)

(21) Appl. No.: 13/098,835

(22) Filed: May 2, 2011

(51) Int. Cl. G06Q 99/00; G06Q 30/00; G06F 15/16

(52) U.S. Cl. 705/27.1; 709/219; 709/203

(57) ABSTRACT

A method of inventory management includes receiving an image comprising one or more items. Next, one or more tags for the image items is received, wherein each tag corresponds with an image item. Item data corresponding to each tagged image item may then be received.

### BACKGROUND OF INVENTION

This application relates generally to an inventory system and more particularly to an inventory system employing images and image tags.

### SUMMARY

Creating inventories of items or belongings is frequently useful for keeping track of such items or belongings. Such inventories are particularly useful for insurance purposes whereby one may be able to prove ownership of certain items or belongings in the event certain items or belongings are stolen, lost, destroyed, damaged, etc. such that the insurance provider may assist in replacing or compensating one for such loss. However, creating useful inventories takes considerable amounts of time even with the employment of modern technologies. Therefore, it would be advantageous to have a system or method that provides a way for easily creating inventories.

In one embodiment, a computer implemented method comprises: receiving an image comprising one or more items; receiving one or more tags for the image items, wherein each tag corresponds with an image item; and receiving item data corresponding to each tagged image item.

In another embodiment, an inventory management device comprises: a memory configured to store a set of instructions; and a processor configured to execute the set of instructions, wherein the set of instructions cause the processor to: receive an image comprising one or more items; receive one or more tags for the image items, wherein each tag corresponds with an image item; and receive item data corresponding to each tagged image item.

In yet another embodiment, an inventory management system comprises: one or more terminals operable to act as a client on a network; a computer operable to act as a server on the network and to communicate with each of the participant terminals over the network, the computer comprising: a memory configured to store a set of instructions; and a processor configured to execute the set of instructions, wherein the set of instructions cause the processor to: receive an image comprising one or more items; receive one or more tags for the image items, wherein each tag corresponds with an image item; and receive item data corresponding to each tagged image item.

### BRIEF DESCRIPTION OF THE DRAWINGS

The drawings, when considered in connection with the following description, are presented for the purpose of facilitating an understanding of the subject matter sought to be protected.

FIG. 1 is an illustration of an inventory management network;

FIG. 2 is a flow diagram of an illustrative process for inventory management; and

FIG. 3 is an illustrative screen shot of an inventory management system.

### DETAILED DESCRIPTION

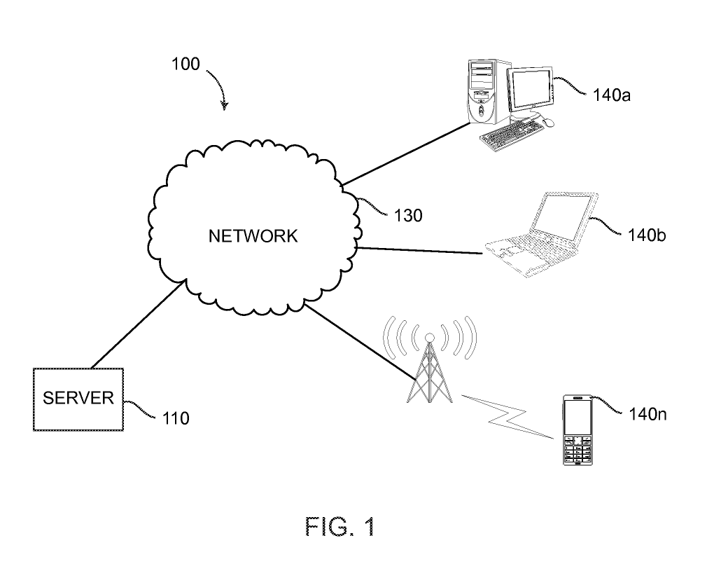

Referring now to FIG. 1, a loan management system 100 is depicted. The system 100 may include a server 110, a communications network 130, and one or more participant terminals 140a-140n (collectively 140). The different elements and components of the system 100 may communicate with one another using wireless communications or hardwired connections, such as fiber optics, cable, DSL, telephone lines, and other similar connections.

The communications network 130 may include any number of networks capable of providing communications between the server 110, and terminals 140. For example, the communications network may be one or more, or any combination of, wireless networks, data or packet networks, publicly switched telephone networks (PSTN), etc.

The participant terminals 140 may include any suitable device operable to act as a client on a network. Illustrative terminals 140 include, but are not limited to, personal computers, desktop computers, laptop computers, servers, or any suitable telecommunications device, including, but not limited to, VoIP telephones, smart telephones or wireless devices, such as cellular telephones, personal digital assistants (PDA), communications enabled mp3 players, etc. Each terminal 140 may be configured to transmit and/or receive information to and/or from the server 110 and/or other participant terminals 140.

The server 110 may be any server, computer or device configured to process commands from the participant terminals 140. For example, the server 110 may be operable to receive an image from one or more terminals 104. Typically, the items in the image are items to be catalogued or inventoried. In one embodiment, the image is a digital image, captured via any suitable means, of a room containing items to be catalogued or inventoried. Also, it will be appreciated that multiple images may be uploaded or otherwise provided to the server 110 wherein each image includes one or more items to be catalogued or inventoried. The images may be provided with data to identify the image (e.g. the name of the room, closet, etc.). Hereafter catalogued or catalogue and inventoried or inventory will be used synonymously and interchangeably. In one non-limiting, illustrative embodiment, each image may be of a different room where each room has at least one item to be inventoried.

The server 110 may receive tags corresponding to each item in image to be inventoried. The processes for tagging items found in images on the server may be akin to those commonly known in the art, which are incorporated herein in full. In one embodiment, the items tagged are the items found in the corresponding room. It will be appreciated that the user may select the items to be catalogued from the room and may choose to not tag certain items found in said room. Alternatively, the user may tag every item in the room. Illustrative items may include, without limitation, furniture, televisions, computers, clothing, decorations, etc. It will be appreciated that anything may be tagged and considered an item and within the scope of the present disclosure.

The server 110 may then receive data corresponding to each tagged item in the image. The data may be any suitable data for identifying the item as well as any other suitable data. For example, and without limitation, suitable data may include the item name, the purchase date of the item, the purchase cost of the item, the sales price of the item, or any other suitable data. The data may further include individual images associated with the item such as an individual image of the item, an image of the purchase receipt associated with the item or any other suitable data. It will be appreciated that the forgoing examples are illustrative only and not to be limiting in any way and additional data will be appreciated by those skilled in the art and are encompassed in the present disclosure. It will also be appreciated that items, tags and or images may be modified or removed from the system.

The server 110 may generate a summary page and/or image of the room whereby the image of the room is displayed with the corresponding tags as well as a generated inventory list. The server 110 may also generate thumbnail images for each item in the room for use in the summary page. The summary page may be accessible by one or more terminals 140.

The server 110 may be configured to receive a sales price for any tagged image item. The server 110 may use the tagged portion of the image corresponding to the item, at least some of the tagged item data along with the sales price and any other suitable information or data to generate a sales page accessible by one or more terminals 140 such that a user may offer to sell one or more of the tagged items. The server 110 may generate a page for view from the server 110 by one or more terminals or generate a webpage for use on a third-party sales website such as craigslist®, eBay® or any other suitable third-party host.

In the illustrative embodiment, the server 110 includes a memory and a processor to accommodate the forgoing. However, it will be appreciated that the forgoing may be implemented in hardware, software, or a suitable combination of hardware and software, and which can be one or more software systems operating on a general purpose server platform. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

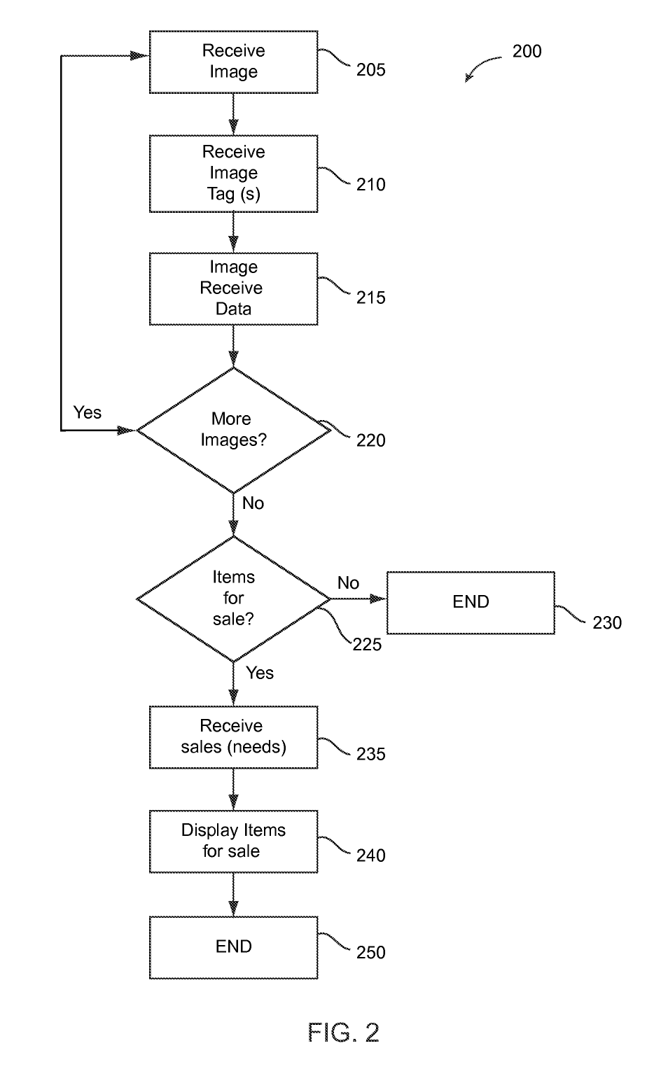

Referring now to FIG. 2, a flowchart 200 of a method of generating an inventory is shown. The method may be implemented by a server, wireless device, VoIP telephone, other advanced intelligence network device, or any combination thereof, generally referred to herein as the “device.”

First, an image having one or more items to be inventoried is received 205. In one embodiment, the image is an image of a room having one or more items to be inventoried. Next, the items depicted in the image to be inventoried are tagged 210. Once the items are tagged, data associated with each item may be received 215. Suitable data may include, without limitation, item name, the purchase date of the item, the purchase cost of the item, the sales price of the item, or any other suitable data.

The device may prompt a user to determine if there are additional images to be tagged 220. If there are additional images to be tagged, they may be received as described above. Alternatively, in at least one embodiment, if there are no more images to be tagged, the method may be complete. In yet another alternative, the device may prompt a user to determine if any of the tagged items are for sale 225. If there are no items to be sold, the method may be complete 230. If there are items for sale, the device may receive a sales price for any such item 235. A user may input the sales price. Alternatively, the sales price may be suggested from similar items previously sold via the device or third-party system or device (e.g. eBay®, craigslist®, etc.).

Once the items for sale are given a sales price, the items may be displayed for sale 240. In one embodiment, the device may generate a webpage for delivery to another device or system in communication with the device. The webpage may include images of the item(s) for sale, sales price, contact information and any other relevant information. Alternatively, the device may generate information, data or a webpage compatible with a third-party website or service (e.g. eBay®, craigslist®) for selling items. Once the items are displayed for sale, the method may be terminated 250.

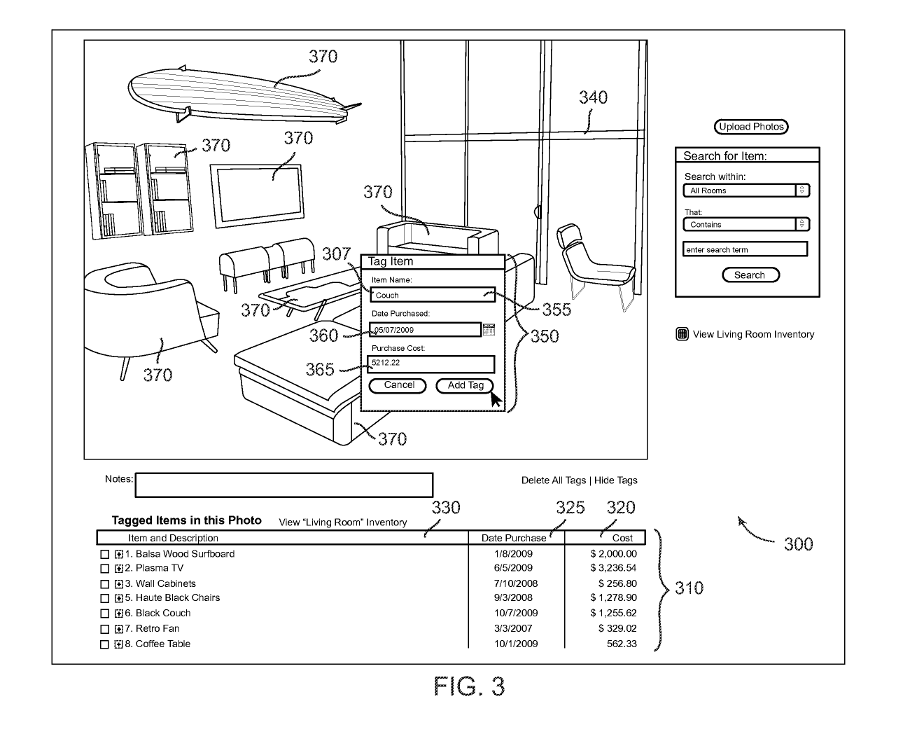

Referring now to FIG. 3, an illustrative screen shot 300 showing a portion of the previously described system and/or method is shown. It will be appreciated that the screenshot is illustrative only and that any suitable display configuration may be employed and remain within the scope of the present disclosure. In the illustrative screen shot 300, a living room 340 is depicted having a plurality of items 370. A prompt 350 may be employed for receiving information about each tagged item 370. For example, and without limitation, the item name 355, date purchased 360 and purchase cost 365 may be provided by the user. As the user tags each item, a list of items 310 may be generated that lists the description of each tagged item 330 as well as purchase date 325 and cost 320.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A computer implemented method comprising:
receiving an image comprising one or more items;
receiving one or more tags for the image items, wherein each tag corresponds with an image item; and
receiving item data corresponding to each tagged image item.

2. The method of claim 1 wherein the image is an image of a room and the items are items found in the room.

3. The method of claim 2 wherein one or more items from the room are tagged.

4. The method of claim 1 wherein the item data includes an item name.

5. The method of claim 1 wherein the item data includes an item purchased date.

6. The method of claim 1 wherein the item data includes an item purchase cost.

7. The method of claim 1 further comprising receiving an image associated with a purchase receipt for the item.

8. The method of claim 1 further comprising generating a thumbnail image for each tagged item.

9. The method of claim 1 further comprising receiving a sales price for one or more tagged item.

10. The method of claim 9 further comprising displaying the tagged items having a sales prices on a website.

11. An inventory management device comprising:
a memory configured to store a set of instructions; and
a processor configured to execute the set of instructions, wherein the set of instructions cause the processor to:
receive an image comprising one or more items;
receive one or more tags for the image items, wherein each tag corresponds with an image item; and
receive item data corresponding to each tagged image item.

12. The device of claim 11 wherein the image is an image of a room and the items are items found in the room and wherein one or more items from the room are tagged.

13. The device of claim 11 wherein the item data includes one or more of an item name, an item purchased date and an item purchase cost.

14. The device of claim 11 wherein the instructions further cause the processor to receive an image associated with a purchase receipt for the item.

15. The device of claim 11 wherein the instructions further cause the processor to receive a sales price for one or more tagged item.

16. The device of claim 15 wherein the instructions further cause the processor to display the tagged items having a sales prices on a website.

17. An inventory management system comprising:
one or more terminals operable to act as a client on a network;
a computer operable to act as a server on the network and to communicate with each of the participant terminals over the network, the computer comprising:
a memory configured to store a set of instructions; and
a processor configured to execute the set of instructions, wherein the set of instructions cause the processor to:
receive an image comprising one or more items;
receive one or more tags for the image items, wherein each tag corresponds with an image item; and
receive item data corresponding to each tagged image item.

18. The system of claim 17 wherein the item data includes one or more of an item name, an item purchased date and an item purchase cost.

19. The system of claim 17 wherein the instructions further cause the processor to receive a sales price for one or more tagged item.

20. The system of claim 19 wherein the instructions further cause the processor to display the tagged items having a sales prices for one or more of the terminals.
